(19) United States
(12) Patent Application Publication
(10) Pub. No.: US 2023/0162899 A1
(43) Pub. Date: May 25, 2023

(54) MULTILAYER COIL COMPONENT

(71) Applicant: Murata Manufacturing Co., Ltd., Kyoto-fu (JP)

(72) Inventor: Katsuhisa Imada, Nagaokakyo-shi (JP)

(73) Assignee: Murata Manufacturing Co., Ltd., Kyoto-fu (JP)

(21) Appl. No.: 18/052,502

(22) Filed: Nov. 3, 2022

(30) Foreign Application Priority Data
Nov. 19, 2021 (JP) 2021-188648

(51) Int. Cl. H01F 5/06; H01F 5/04; H01F 27/28

(52) U.S. Cl. CPC H01F 5/06; H01F 5/04; H01F 27/2847

(57) ABSTRACT

A multilayer coil component includes a multilayer body which includes stacked insulating layers and incorporates a coil, and outer electrodes on an outer surface of the multilayer body and are electrically connected to the coil. The coil includes coil conductors which are stacked together with the insulating layers are electrically connected together. The coil conductors each include inner and outer end faces which face each other in a direction orthogonal to a stacking direction of the multilayer body in a section in a width direction of the one of the coil conductors. At least one end face of the inner end face and the outer end face in at least one coil conductor includes a first surface and a second surface which is continuous with the first surface and is different in an angle with respect to a plane perpendicular to the stacking direction from the first surface.

### CROSS-REFERENCE TO RELATED APPLICATION

This application claims benefit of priority to Japanese Patent Application No. 2021-188648, filed Nov. 19, 2021, the entire content of which is incorporated herein by reference.

### BACKGROUND

### Technical Field

The present disclosure relates to a multilayer coil component.

### Background Art

Japanese Unexamined Patent Application Publication No. 2017-59749 describes a multilayer coil component including an element body containing a magnetic material, a coil including a plurality of internal conductors which are spaced apart from each other in a first direction and are electrically connected together inside the element body, and a plurality of stress-relaxing spaces which are in contact with surfaces of the internal conductors and in which powders are present.

### SUMMARY

Japanese Unexamined Patent Application Publication No. 2017-59749 discloses a configuration in which a section in a width direction of a coil conductor is trapezoidal or rectangular. If a section in a width direction of a coil conductor is trapezoidal or rectangular, stress due to a differential shrinkage between the coil conductor and an element body at the time of firing is likely to concentrate on a corner portion of the coil conductor. As a result, a crack may appear inside a multilayer coil component.

Accordingly, the present disclosure provides a multiplayer coil component in which stress concentration in a coil conductor is inhibited.

A multilayer coil component according to the present disclosure is a multilayer coil component including a multilayer body which is composed of a plurality of insulating layers stacked and incorporates a coil, and an outer electrode which is provided on an outer surface of the multilayer body and is electrically connected to the coil. The coil is formed by a plurality of coil conductors which are stacked together with the insulating layers being electrically connected together. The coil conductors each include an inner end face and an outer end face which face each other in a direction orthogonal to a stacking direction of the multilayer body in a section in a width direction of the coil conductor. The inner end face is located on an inner side of the multilayer body in the section in the width direction of the coil conductor. The outer end face is located on an outer side of the multilayer body in the section in the width direction of the coil conductor. At least one end face of the inner end face and the outer end face in at least one of the coil conductors includes a first surface and a second surface which is continuous with the first surface and is different in an angle with respect to a plane perpendicular to the stacking direction from the first surface.

According to the present disclosure, it is possible to provide a multilayer coil component in which stress concentration in a coil conductor is inhibited.

### BRIEF DESCRIPTION OF THE DRAWINGS

FIG. 1 is a perspective view schematically showing an example of a multilayer coil component according to the present disclosure;

FIG. 2 is a schematic view transparently showing an interior of the multilayer coil component according to the present disclosure such that a structure of a coil is understandable;

FIG. 3 is an LT sectional view schematically showing an internal structure of the multilayer coil component according to the present disclosure;

FIG. 4 is a WT sectional view schematically showing the internal structure of the multilayer coil component according to the present disclosure;

FIG. 5 is a sectional view schematically showing an example of a shape of a section in a width direction of a coil conductor;

FIG. 6A1 to 6D4 are exploded views schematically showing a method for producing a multilayer body;

FIGS. 7A-7C are sectional views for explaining a process of stacking a conductive paste layer and a ferrite paste layer;

FIG. 8 is a sectional view schematically showing a coil conductor and an insulating layer after firing;

FIG. 9 is an LT sectional view schematically showing an internal structure of a different example of the multilayer coil component according to the present disclosure;

FIG. 10-1A1 to 10-1B4′ are exploded views schematically showing a method for producing a multilayer body of the different example of the multilayer coil component according to the present disclosure;

FIG. 10-2C1 to 10-2D4′ are exploded views schematically showing the method for producing the multilayer body of the different example of the multilayer coil component according to the present disclosure; and

FIGS. 11A-11C are views showing results of simulating stress applied to a corner portion of a coil conductor in a process of firing a multilayer coil component.

### DETAILED DESCRIPTION

A multilayer coil component according to the present disclosure will be described below.

The present disclosure, however, is not limited to the configurations and aspects below, and can be appropriately changed and applied without departing from the spirit of the present disclosure. Note that a combination of two or more of individual preferred configurations and aspects of the present disclosure to be described below is also included in the present disclosure.

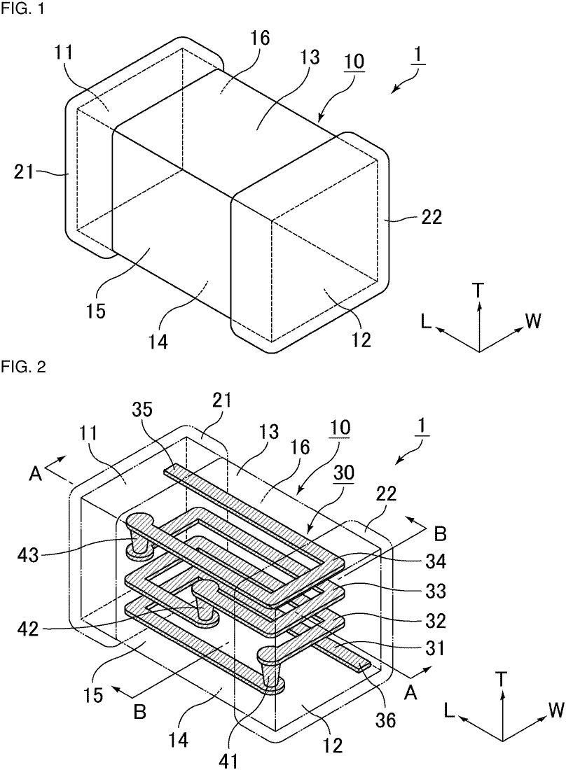

FIG. 1 is a perspective view schematically showing an example of the multilayer coil component according to the present disclosure.

A multilayer coil component 1 shown in FIG. 1 includes a multilayer body 10 and a first outer electrode 21 and a second outer electrode 22 which are provided on an outer surface of the multilayer body 10. The multilayer body 10 has a substantially rectangular parallelepiped shape having six surfaces. A configuration of the multilayer body 10 will be described later.

As for the multilayer coil component 1 and the multilayer body 10, a direction in which the first outer electrode 21 and the second outer electrode 22 face each other will be referred to as a length direction L. A direction orthogonal to the length direction L will be referred to as a height direction T, and a direction orthogonal to the length direction L and the height direction T will be referred to as a width direction W.

In FIG. 1, the length direction L, the width direction W, and the height direction T in the multilayer coil component 1 and the multilayer body 10 are shown as directions of double-headed arrows L, W, and T.

The length direction L, the width direction W, and the height direction T are orthogonal to one another.

A surface to be mounted of the multilayer coil component 1 is a surface (LW surface) parallel to the length direction L and the width direction W.

The multilayer body 10 shown in FIG. 1 has a first end face 11 and a second end face 12 which are opposed to each other in the length direction L, a first principal surface 13 and a second principal surface 14 which are opposed to each other in the height direction T orthogonal to the length direction L, and a first side surface 15 and a second side surface 16 which are opposed to each other in the width direction W orthogonal to the length direction L and the height direction T.

Although not shown in FIG. 1, a multilayer body is preferably rounded at corner portions and ridge line portions. A corner portion is a portion where three surfaces of the multilayer body intersect, and a ridge line portion is a portion where two surfaces of the multilayer body intersect.

The first outer electrode 21 is arranged so as to cover the first end face 11 of the multilayer body 10, extend from the first end face 11, and cover a part of the first principal surface 13, a part of the second principal surface 14, a part of the first side surface 15, and a part of the second side surface 16, as shown in FIG. 1. The second outer electrode 22 is arranged so as to cover the second end face 12 of the multilayer body 10, extend from the second end face 12, and cover a part of the first principal surface 13, a part of the second principal surface 14, a part of the first side surface 15, and a part of the second side surface 16, as shown in FIG. 1.

The second principal surface 14 serves as the surface to be mounted.

FIG. 2 is a schematic view transparently showing an interior of the multilayer coil component according to the present disclosure such that a structure of a coil is understandable.

The multilayer body 10 includes a plurality of coil conductors 31, 32, 33, and 34, lead-out conductors 35 and 36, and a plurality of via conductors 41, 42, and 43.

The coil conductors 31, 32, 33, and 34 are arranged in order from a lower side in the height direction T.

The coil conductor 31 is continuous with the lead-out conductor 36. The coil conductor 31 is electrically connected to the second outer electrode 22 at the second end face 12 via the lead-out conductor 36. The coil conductor 34 is continuous with the lead-out conductor 35. The coil conductor 34 is electrically connected to the first outer electrode 21 at the first end face 11 via the lead-out conductor 35.

The coil conductors 31 to 34 are electrically connected together via the via conductors 41 to 43.

The coil conductor 31 is electrically connected to the via conductor 41 at an end portion which is not continuous with the lead-out conductor 36. The coil conductor 32 is electrically connected to the via conductor 41 at one end portion. The coil conductor 32 is electrically connected to the via conductor 42 at an end portion which is not electrically connected to the via conductor 41. The coil conductor 33 is electrically connected to the via conductor 42 at one end portion. The coil conductor 33 is electrically connected to the via conductor 43 at an end portion which is not electrically connected to the via conductor 42. The coil conductor 34 is electrically connected to the via conductor 43 at an end portion which is not continuous with the lead-out conductor 35.

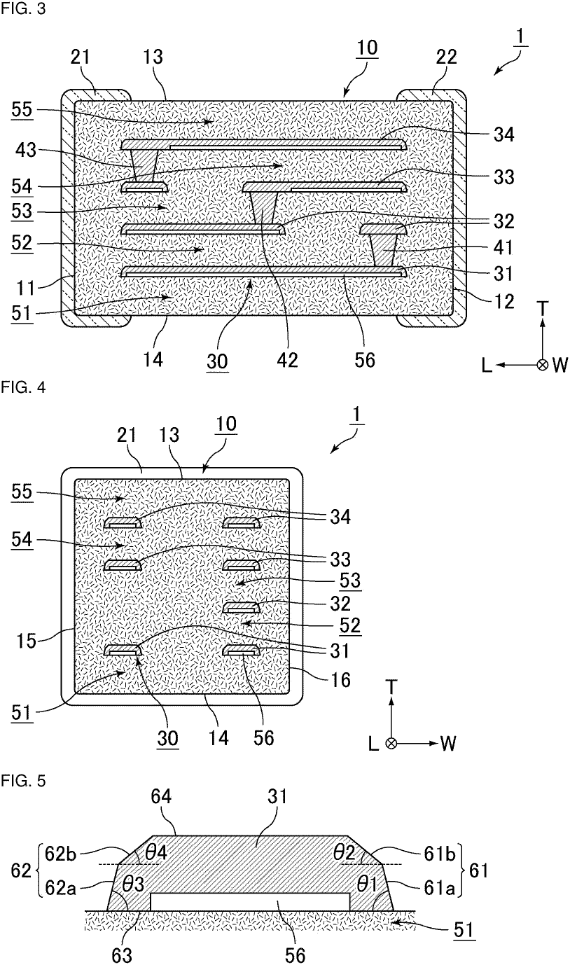

FIG. 3 is an LT sectional view schematically showing an internal structure of the multilayer coil component according to the present disclosure. FIG. 3 is a sectional view taken along line A-A of the multilayer coil component in FIG. 2.

FIG. 4 is a WT sectional view schematically showing the internal structure of the multilayer coil component according to the present disclosure. FIG. 4 is a sectional view taken along line B-B of the multilayer coil component in FIG. 2.

The multilayer body 10 is composed of a plurality of insulating layers 51, 52, 53, 54, and 55 stacked and incorporates a coil 30.

The coil 30 is formed by the plurality of coil conductors 31, 32, 33, and 34 that are stacked together with the insulating layers 51, 52, 53, 54, and 55 being electrically connected together. The first outer electrode 21 and the second outer electrode 22 are electrically connected to the coil 30. In FIGS. 2 to 4, a conductor which leads the coil 30 to the first end face 11 is the lead-out conductor 35, and a conductor which leads the coil 30 to the second end face 12 is the lead-out conductor 36. A position where a coil conductor and an outer electrode are to be connected can be changed by changing a position where the coil conductor is to be led out of a multilayer body. The lead-out position may be changed, and the coil conductor and the outer electrode may be electrically connected at a principal surface or a side surface of the multilayer body.

The insulating layer 51 is present between the coil conductor 31 and the second principal surface 14 of the multilayer body 10. The insulating layer 52 is present between the coil conductor 31 and the coil conductor 32. The insulating layer 53 is present between the coil conductor 32 and the coil conductor 33. The insulating layer 54 is present between the coil conductor 33 and the coil conductor 34. The insulating layer 55 is present between the coil conductor 34 and the first principal surface 13 of the multilayer body 10.

The via conductors 41, 42, and 43 extend through the insulating layers 52, 53, and 54, respectively, in the height direction T.

Respective void portions 56 are preferably present between the coil conductors 31, 32, 33, and 34 and the insulating layers 51, 52, 53, and 54. In FIGS. 3 and 4, the void portions 56 are present on lower sides in the height direction T of the coil conductors 31, 32, 33, and 34. The void portions 56 will be described later in detail.

FIG. 5 is a sectional view schematically showing an example of a shape of a section in a width direction of a coil conductor.

The coil conductor 31 has an inner end face 61 and an outer end face 62 which are two end faces facing each other in a direction orthogonal to a stacking direction of the multilayer body in a section in a width direction.

The coil conductor 31 preferably has a first principal surface 63 and a second principal surface 64 which are two principal surfaces facing each other in the stacking direction of the multilayer body in a section in the width direction.

The inner end face 61 is an end face which is present on an inner side of the multilayer body of the two end faces facing each other in the direction orthogonal to the stacking direction of the multilayer body. The outer end face 62 is an end face which is present on an outer side of the multilayer body of the two end faces facing each other in the direction orthogonal to the stacking direction of the multilayer body.

In the multilayer coil component according to the present disclosure, at least one end face of an inner end face and an outer end face in at least one coil conductor includes a first surface and a second surface which is continuous with the first surface and is different in an angle with respect to a plane perpendicular to the stacking direction from the first surface.

Note that “continuity” between surfaces in the present disclosure is not limited to a case where a first surface and a second surface are connected to have a flection and that the first surface and the second surface only need to be substantially continuous. For example, a case where a minute curved surface is interposed between the first surface and the second surface is also included.

If at least one end face of an inner end face and an outer end face includes a first surface and a second surface in a coil conductor, the following effect is produced.

Since a differential shrinkage occurs between a coil conductor and an insulating layer at the time of firing, stress due to the differential shrinkage is likely to concentrate on a corner portion of the coil conductor. If at least one end face of an inner end face and an outer end face includes a first surface and a second surface which is continuous with the first surface and is different in an angle with respect to a plane perpendicular to the above-described stacking direction from the first surface in the coil conductor, stress is also dispersed to a corner portion where the first surface and the second surface are in contact with each other. This results in inhibition of stress concentration on a corner portion of the coil conductor. For this reason, appearance of a crack inside a multilayer coil component is inhibited.

In FIG. 5, a first surface 61a and a second surface 61b are present in the inner end face 61 in the section in the width direction of the coil conductor 31.

The first surface 61a of the inner end face 61 is in contact with the second surface 61b of the inner end face 61 at one end portion. The first surface 61a of the inner end face 61 and the second surface 61b of the inner end face 61 are continuous with each other. If a plane on a side of the coil conductor of planes perpendicular to the stacking direction of the multilayer body is regarded as a reference plane, an angle with respect to the reference plane at an end portion of the first surface 61a of the inner end face 61 which is not in contact with the second surface 61b of the inner end face 61 is a first angle θ1 of the inner end face 61. Note that the end portion in the first surface 61a of the inner end face 61 that is not in contact with the second surface 61b of the inner end face 61 is one and the same as an end portion which is in contact with the first principal surface 63 in FIG. 5. The plane on the side of the coil conductor of planes perpendicular to the stacking direction of the multilayer body is one and the same as the first principal surface 63 in FIG. 5.

The second surface 61b of the inner end face 61 is in contact with the first surface 61a of the inner end face 61 at one end portion. In FIG. 5, the second surface 61b of the inner end face 61 is in contact with the second principal surface 64 that is one of the two principal surfaces facing each other in the stacking direction of the multilayer body at the other end portion. If the plane on the side of the coil conductor of planes perpendicular to the stacking direction of the multilayer body is regarded as a reference plane, an angle with respect to the reference plane at the end portion of the second surface 61b of the inner end face 61 that is in contact with the first surface 61a of the inner end face 61 is a second angle θ2 of the inner end face 61.

In FIG. 5, a first surface 62a and a second surface 62b are present in the outer end face 62 in the section in the width direction of the coil conductor 31.

The first surface 62a of the outer end face 62 is in contact with the second surface 62b of the outer end face 62 at one end portion. The first surface 62a of the outer end face 62 and the second surface 62b of the outer end face 62 are continuous with each other. If a plane on a side of the coil conductor of planes perpendicular to the stacking direction of the multilayer body is regarded as a reference plane, an angle with respect to the reference plane at an end portion of the first surface 62a of the outer end face 62 which is not in contact with the second surface 62b of the outer end face 62 is a first angle θ3 of the outer end face 62. Note that the end portion in the first surface 62a of the outer end face 62 that is not in contact with the second surface 62b of the outer end face 62 is one and the same as an end portion which is in contact with the first principal surface 63 in FIG. 5. The plane on the side of the coil conductor of planes perpendicular to the stacking direction of the multilayer body is one and the same as the first principal surface 63 in FIG. 5.

The second surface 62b of the outer end face 62 is in contact with the first surface 62a of the outer end face 62 at one end portion. In FIG. 5, the second surface 62b of the outer end face 62 is in contact with the second principal surface 64 that is one of the two principal surfaces facing each other in the stacking direction of the multilayer body at the other end portion. If the plane on the side of the coil conductor of planes perpendicular to the stacking direction of the multilayer body is regarded as a reference plane, an angle with respect to the reference plane at the end portion of the second surface 62b of the outer end face 62 that is in contact with the first surface 62a of the outer end face 62 is a second angle θ4 of the outer end face 62.

Although the coil conductor 31 is shown as an example in FIG. 5, it is only required that at least one end face of an inner end face and an outer end face in at least one coil conductor of a plurality of coil conductors constituting a coil includes a first surface and a second surface. In the multilayer coil component 1, at least one end face of an inner end face and an outer end face of the coil conductor 31, 32, 33, or 34 only needs to include a first surface and a second surface. All inner end faces and all outer end faces in a plurality of coil conductors constituting a coil may each include a first surface and a second surface.

It is preferable that, of the first angle θ1 of the inner end face 61 and the second angle θ2 of the inner end face 61, one angle is not more than 90° and that the other angle is less than 90°. If the first angle θ1 of the inner end face 61 and the second angle θ2 of the inner end face 61 satisfy the above-described condition, stress concentration on a corner portion of the coil conductor is further inhibited. The first angle θ1 of the inner end face 61 may be not more than 90°, and the second angle θ2 of the inner end face 61 may be less than 90°. Alternatively, the first angle θ1 of the inner end face 61 may be less than 90°, and the second angle θ2 of the inner end face 61 may be not more than 90°.

It is more preferable that, of the first angle θ1 of the inner end face 61 and the second angle θ2 of the inner end face 61, one angle is not less than 40° and not more than 85° (i.e., from 40° to 85°) and that the other angle is not less than 5° and not more than 30° (i.e., from 5° to 30°). If the first angle θ1 of the inner end face 61 and the second angle θ2 of the inner end face 61 satisfy the above-described condition, stress concentration on a corner portion of the coil conductor is further inhibited. The first angle θ1 of the inner end face 61 may be not less than 40° and not more than 85° (i.e., from 40° to 85°), and the second angle θ2 of the inner end face 61 may be not less than 5° and not more than 30° (i.e., from 5° to 30°). Alternatively, the first angle θ1 of the inner end face 61 may be not less than 5° and not more than 30° (i.e., from 5° to 30°), and the second angle θ2 of the inner end face 61 may be not less than 40° and not more than 85° (i.e., from 40° to 85°).

The first angle θ1 of the inner end face 61 is preferably larger than the second angle θ2 of the inner end face 61. If the first angle θ1 of the inner end face 61 and the second angle θ2 of the inner end face 61 satisfy the above-described relation, stress concentration on a corner portion of the coil conductor is further inhibited.

It is preferable that, of the first angle θ3 of the outer end face 62 and the second angle θ4 of the outer end face 62, one angle is not more than 90° and that the other angle is less than 90°. If the first angle θ3 of the outer end face 62 and the second angle θ4 of the outer end face 62 satisfy the above-described condition, stress concentration on a corner portion of the coil conductor is further inhibited. The first angle θ3 of the outer end face 62 may be not more than 90°, and the second angle θ4 of the outer end face 62 may be less than 90°. Alternatively, the first angle θ3 of the outer end face 62 may be less than 90°, and the second angle θ4 of the outer end face 62 may be not more than 90°.

It is more preferable that, of the first angle θ3 of the outer end face 62 and the second angle θ4 of the outer end face 62, one angle is not less than 40° and not more than 85° (i.e., from 40° to 85°) and that the other angle is not less than 5° and not more than 30° (i.e., from 5° to 30°). If the first angle θ3 of the outer end face 62 and the second angle θ4 of the outer end face 62 satisfy the above-described condition, stress concentration on a corner portion of the coil conductor is further inhibited. The first angle θ3 of the outer end face 62 may be not less than 40° and not more than 85° (i.e., from 40° to 85°), and the second angle θ4 of the outer end face 62 may be not less than 5° and not more than 30° (i.e., from 5° to 30°). Alternatively, the first angle θ3 of the outer end face 62 may be not less than 5° and not more than 30° (i.e.., from 5° to 30°), and the second angle θ4 of the outer end face 62 may be not less than 40° and not more than 85° (i.e., from 40° to 85°).

The first angle θ3 of the outer end face 62 is preferably larger than the second angle θ4 of the outer end face 62. If the first angle θ3 of the outer end face 62 and the second angle θ4 of the outer end face 62 satisfy the above-described relation, stress concentration on a corner portion of the coil conductor is further inhibited.

The first angle θ1 of the inner end face 61 and the first angle θ3 of the outer end face 62 may be the same or may be different.

The second angle θ2 of the inner end face 61 and the second angle θ4 of the outer end face 62 may be the same or may be different.

Although the first surface 61a of the inner end face 61 and the second surface 61b of the inner end face 61 are shown to be linear in FIG. 5, the first surface 61a and the second surface 61b may be curved.

A method for measuring the first angle θ1 of the inner end face 61 is as follows. A straight line is drawn between the end portion of the first surface 61a of the inner end face 61 that is in contact with the second surface 61b of the inner end face 61 and the end portion of the first surface 61a of the inner end face 61 that is not in contact with the second surface 61b of the inner end face 61. An angle which the straight line forms with the plane on the side of the coil conductor of planes perpendicular to the stacking direction of the multilayer body is measured and the angle is set as the first angle θ1 of the inner end face 61.

A method for measuring the second angle θ2 of the inner end face 61 is as follows. A straight line is drawn between the end portion of the second surface 61b of the inner end face 61 that is in contact with the first surface 61a of the inner end face 61 and the end portion of the second surface 61b of the inner end face 61 that is not in contact with the first surface 61a of the inner end face 61. An angle which the straight line forms with the plane on the side of the coil conductor of planes perpendicular to the stacking direction of the multilayer body is measured and the angle is set as the second angle θ2 of the inner end face 61.

Although the first surface 62a of the outer end face 62 and the second surface 62b of the outer end face 62 are shown to be linear in FIG. 5, the first surface 62a and the second surface 62b may be curved.

A method for measuring the first angle θ3 of the outer end face 62 is the same as that for the first angle θ1 of the inner end face 61. A method for measuring the second angle θ4 of the outer end face 62 is the same as that for the second angle θ2 of the inner end face 61.

In the present specification, a width direction of a coil conductor is a direction orthogonal to a length direction of the coil conductor on a plane where the coil conductor is present. The length direction of the coil conductor is a direction in which the coil conductor extends on the plane where the coil conductor is present. Thus, a width direction of a coil conductor does not necessarily coincide with the width direction W in FIGS. 1 to 4, and a length direction of the coil conductor does not necessarily coincide with the length direction L in FIGS. 1 to 4.

For example, sections of the coil conductors 31 and 34 shown in FIG. 3 are all sections in length directions of the coil conductors.

Meanwhile, a section on a right side in FIG. 3 of the coil conductor 32 is a section in a width direction of the coil conductor, and a section on a left side in FIG. 3 of the coil conductor 32 is a section in a length direction of the coil conductor. A section on the left side in FIG. 3 of the coil conductor 33 is a section in a width direction of the coil conductor, and a section on the right side in FIG. 3 of the coil conductor 33 is a section in a length direction of the coil conductor.

Sections of the coil conductors 31, 32, 33, and 34 shown in FIG. 4 are all sections in width directions of the coil conductors.

A void portion is preferably present between at least one of coil conductors which includes a first surface and a second surface and an insulating layer.

For the coil conductor 31, the void portion 56 is present between the coil conductor 31 and the insulating layer 51.

FIG. 5 shows a configuration in which the coil conductor 31 is present on the insulating layer 51, and the void portion 56 is present between the insulating layer 51 and the coil conductor 31. The void portion 56 is formed at a position slightly inward from end portions of the coil conductor 31.

Since a ceramic material (for example, a ferrite material), of which an insulating layer is composed, shrinks more than a metal material (for example, silver), of which a coil conductor is composed, at the time of sintering, an unnecessary force is applied between the ceramic material and the metal material. This causes degradation of inductance and impedance of a multilayer coil component.

If a void portion is provided between an insulating layer and a coil conductor, contact between a ceramic material and a metal material decreases, and a force applied between the ceramic material and the metal material at the time of sintering is relaxed.

For this reason, inductance and impedance of a multilayer coil component can be inhibited from degrading.

The coil conductor 31 includes the first principal surface 63 and the second principal surface 64 that are the two principal surfaces facing each other in the stacking direction of the multilayer body, and the void portion 56 may be present so as to be in contact with either one of the first principal surface 63 and the second principal surface 64.

A width of the void portion 56 may be smaller than a width of the coil conductor 31.

The width of the coil conductor 31 means a width at a portion where the coil conductor 31 has a largest width in a section in the stacking direction of the coil conductor 31. In FIG. 5, the width of the coil conductor 31 is the same as a width of the first principal surface 63.

An example of a method for manufacturing the multilayer coil component according to the present disclosure will next be described.

A ferrite sheet, a ferrite paste, a resin paste, and a conductive paste as materials are first prepared.

For the ferrite sheet, a ferrite material containing Fe, Zn, Cu, and Ni as main ingredients is preferably used. It is preferable that the ferrite material contains 40 mol% or more to 49.5 mol% or less (i.e., from 40 mol% to 49.5 mol%) of Fe in terms of Fe₂O₃, 5 mol% or more to 35 mol% or less (i.e., from 5 mol% to 35 mol%) of Zn in terms of ZnO, and 4 mol% or more to 12 mol% or less (i.e., from 4 mol% to 12 mol%) of Cu in terms of CuO. An Ni content of the ferrite material is not particularly limited, and what is left after Fe, Zn, and Cu that are the other main ingredients are taken away can be set as the Ni content. The material may be made to contain trace additives (including inevitable impurities), such as Bi, Sn, Mn, and Co.

As a method for producing the ferrite sheet, for example, the following method can be named.

Fe₂O₃, ZnO, CuO, NiO, and optionally additives are weighed so as to achieve a predetermined composition. The weighed substances, pure water, a dispersant, and PSZ media (partially stabilized zirconia) are put in a ball mill, mixed, and milled. After obtained slurry is dried, the slurry is calcined at a temperature not less than 700° C. and not more than 800° C. (i.e., from 700° C. to 800° C.), thereby obtaining calcined powder of a ferrite material.

The calcined powder of the ferrite material obtained in the above-described manner, an organic binder based on, for example, polyvinyl butyral, an organic solvent, such as ethanol or toluene, and PSZ media are put in a ball mill, mixed, and milled. After an obtained mixture is formed into a sheet of predetermined thickness by a doctor blade method, pieces of predetermined size are stamped out of the sheet. In this manner, a ferrite sheet can be produced.

For the ferrite paste, a ferrite material containing Fe, Zn, Cu, and Ni as main ingredients is preferably used. It is preferable that the ferrite material contains 40 mol% or more to 49.5 mol% or less (i.e., from 40 mol% to 49.5 mol%) of Fe in terms of Fe₂O₃, 5 mol% or more to 35 mol% or less (i.e., from 5 mol% to 35 mol%) of Zn in terms of ZnO, and 4 mol% or more to 12 mol% or less (i.e., from 4 mol% to 12 mol%) of Cu in terms of CuO. An Ni content of the ferrite material is not particularly limited, and what is left after Fe, Zn, and Cu that are the other main ingredients are taken away can be set as the Ni content. The material may be made to contain trace additives (including inevitable impurities), such as Bi, Sn, Mn, and Co.

As a method for producing the ferrite paste, for example, the following method can be named.

A predetermined amount of solvent, such as a ketones solvent, resin, such as polyvinyl acetal, and a plasticizer, such as an alkyd plasticizer, are added to calcined powder of a ferrite material which is obtained in the same manner as the above-described method for producing the ferrite sheet, and an obtained mixture is kneaded by a planetary mixer. After that, the mixture is further dispersed by a triple roll mill. In this manner, a ferrite paste can be produced.

The resin paste is a paste for forming a resin layer between a ceramic paste and the conductive paste, and a void portion is formed by burning off the resin layer after firing.

As a method for producing the resin paste, for example, the following method can be named.

A resin paste is produced by causing a solvent (for example, isophorone) to contain resin (for example, acrylic resin) to be burned off at the time of firing.

It is preferable to use, as the conductive paste, a paste containing silver as a conductive material.

As a method for producing the conductive paste, for example, the following method can be named.

Silver powder is prepared, a predetermined amount of solvent (for example, eugenol), resin (for example, ethylcellulose), and a dispersant are put. After an obtained mixture is kneaded by a planetary mixer, the mixture is dispersed by a triple roll mill. In this manner, a conductive paste is produced.

An example of a method for producing a multilayer body using the above-described materials will next be described.

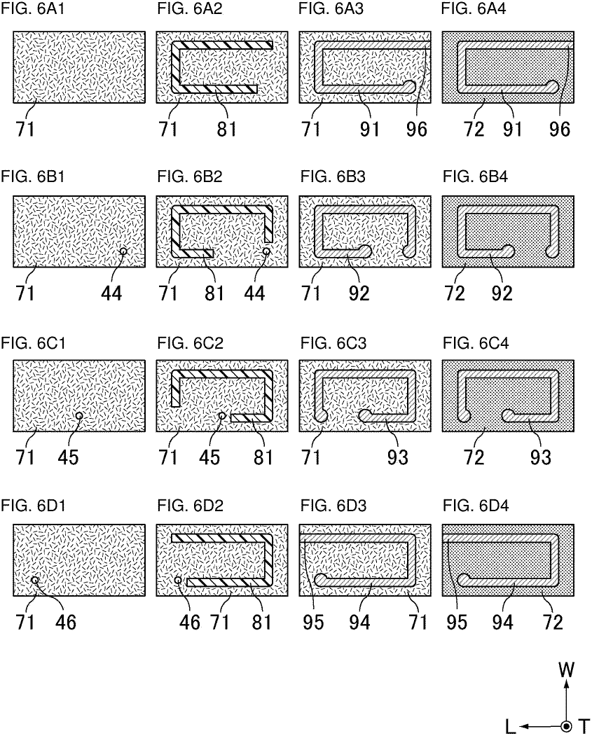

FIG. 6A1-6D4 are exploded views schematically showing the method for producing a multilayer body.

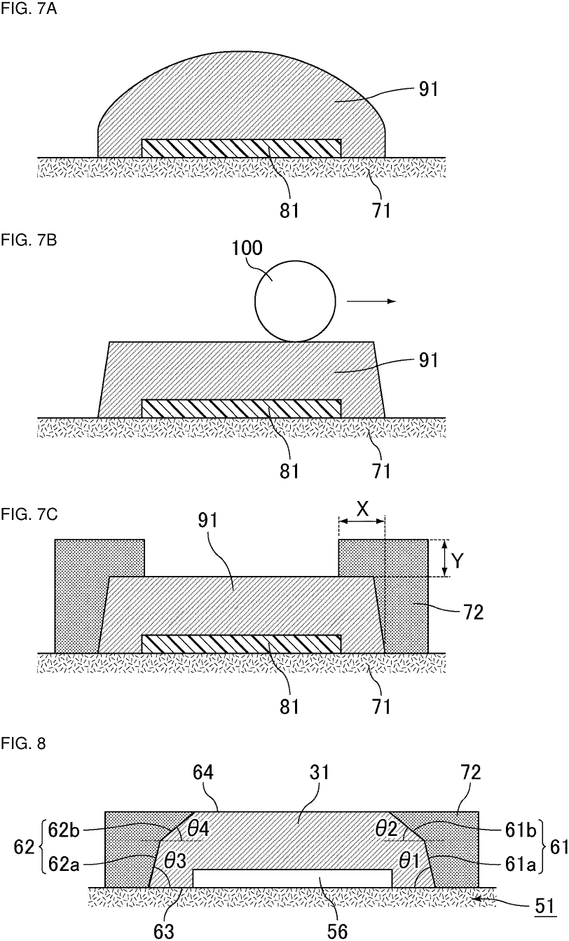

FIGS. 7A-7C are sectional views for explaining a process of stacking a conductive paste layer and a ferrite paste layer.

First, a ferrite sheet 71 is prepared (FIG. 6A1).

Then, a resin paste is applied to an area where a void portion is to be formed on the ferrite sheet 71, and a resin paste layer 81 is formed (FIG. 6A2).

Then, a conductive paste is applied to an area where a coil conductor is to be formed, and a conductive paste layer 91 and a lead-out conductor portion 96 are formed (FIG. 6A3). In this case, a section in a width direction of the conductive paste layer 91 has a so-called dome shape, in which a surface is rounded and a thickness in the stacking direction at a middle portion is larger than thicknesses in the stacking direction at end portions (FIG. 7A).

Then, the conductive paste layer 91 is pressurized using a calendering roll 100, thereby planarizing a surface of the conductive paste layer 91 (FIG. 7B). With this operation, corner portions are formed at the surface of the conductive paste layer 91.

Then, a ferrite paste is applied to a region where the conductive paste layer 91 is not formed, and a ferrite paste layer 72 is formed (FIG. 6A4). The ferrite paste layer 72 serves as the insulating layer 51 surrounding a coil conductor after firing. Here, the application is performed such that the ferrite paste layer 72 overlaps with a part of each end portion of the conductive paste layer 91 by a predetermined length (a length indicated by a double-headed arrow X in FIG. 7C) and a predetermined thickness (a thickness indicated by a double-headed arrow Y in FIG. 7C) (FIG. 7C).

With the above-described steps, pattern sheet 1 on which the resin paste layer 81, the lead-out conductor portion 96, the conductive paste layer 91, and the ferrite paste layer 72 are printed is formed.

The ferrite sheet 71 is separately prepared, and laser is applied to an area which is to be connected to the conductive paste layer 91 formed on pattern sheet 1, and a via hole 44 is formed (FIG. 6B1).

Then, the resin paste is applied to an area where a void portion is to be formed, and the resin paste layer 81 is formed (FIG. 6B2).

Then, the conductive paste is applied to an area where a coil conductor is to be formed, a conductive paste layer 92 is formed, and the via hole 44 is filled with the conductive paste (FIG. 6B3).

Then, the ferrite paste is applied to a region where the conductive paste layer 92 is not formed, and the ferrite paste layer 72 is formed. Here, as in pattern sheet 1, the application is performed such that the ferrite paste layer 72 overlaps with a part of each end portion of the conductive paste layer 92 (FIG. 6B4).

With the above-described steps, pattern sheet 2 on which the resin paste layer 81, the conductive paste layer 92, and the ferrite paste layer 72 are printed is formed.

Pattern sheet 3 and pattern sheet 4 are produced by the same procedures as pattern sheet 2 (FIG. 6C1 to 6C4 and FIG. 6D1 to 6D4). Note that a conductive paste layer 94 and a lead-out conductor portion 95 are formed on pattern sheet 4 (FIG. 6D3).

Pattern sheet 1, pattern sheet 2, pattern sheet 3, and pattern sheet 4 produced in the above-described manner are stacked in order, and a predetermined number of unprinted ferrite sheets are stacked on the top and bottom. The stacked sheets are subjected to pressurization and pressure bonding processing under a condition with a temperature not less than 70° C. and not more than 90° C. (i.e., from 70° C. to 90° C.) and a pressure not less than 60 MPa and not more than 100 MPa (i.e., from 60 MPa to 100 MPa), thereby obtaining a multilayer body block (element assembly).

Then, elements are obtained by cutting the multilayer body block with a dicer or the like into individual pieces. After that, the obtained elements are fired in a firing furnace at a temperature not less than 880° C. and not more than 950° C. (i.e., from 880° C. to 950° C.) for one hour or more to eight hours or less (i.e., from one hour to eight hours).

It is preferable to round ridge line portions and corner portions of each fired element by putting the element in a rotating barrel machine together with a medium and rotating the rotating barrel machine. With the above-described steps, electronic component element bodies are obtained.

Then, a conductive paste containing silver and glass is applied to end faces which are side surfaces of each element and to which a coil is led. An underlying electrode of each outer electrode is formed by baking the conductive paste at a temperature not less than 600° C. and not more than 850° C. (i.e., from 600° C. to 850° C.). After that, the outer electrode is formed by sequentially forming an Ni coating and an Sn coating on the underlying electrode by electrolytic plating, thereby obtaining the multilayer coil component 1 as shown in FIG. 1. The thicknesses of the Ni coating and the Sn coating may be, for example, about 3 µm. A multilayer coil component produced by the above-described method may have, for example, the following dimensions: L (length) = 1.0 mm, W (width) = 0.5 mm, and T (height) = 0.5 mm.

Note that the ferrite sheets 71 and the ferrite paste layers 72 in FIG. 6A1-6D4 serve as the insulating layers 51, 52, 53, and 54 after firing. The resin paste layers 81 in FIG. 6A1-6D4 serve as the void portions 56 after firing. The conductive paste layers 91 and 92, a conductive paste layer 93, and the conductive paste layer 94 in FIG. 6A1-6D4 serve as the coil conductors 31, 32, 33, and 34, respectively, after firing. The lead-out conductor portions 95 and 96 in FIG. 6A1-6D4 serve as the lead-out conductors 35 and 36, respectively, after firing. The conductive pastes, with which the via hole 44 and via holes 45 and 46 in FIG. 6A1-6D4 are filled, serve as the via conductors 41, 42, and 43, respectively, after firing.

FIG. 8 is a sectional view schematically showing a coil conductor and an insulating layer after firing.

A method for forming a first surface and a second surface at each end face in a section in a width direction of a coil conductor will be described with reference to FIGS. 7A-7C and 8.

As shown in FIG. 7C, in pattern sheet 1 before firing, the ferrite paste layer 72 overlaps with a part of each end portion of the conductive paste layer 91 by the predetermined length X and the predetermined thickness Y. In the pressurization and pressure bonding step, a higher pressure is applied to a portion where the ferrite paste layer 72 overlaps with the conductive paste layer 91 than in a portion where the ferrite paste layer 72 does not overlap. As a result, in the coil conductor 31, at least one end face of the inner end face 61 and the outer end face 62 includes the first surface 61a or 62a and the second surface 61b or 62b that is continuous with the first surface 61a or 62a and is different in an angle with respect to a plane perpendicular to the stacking direction of the multilayer body from the first surface 61a or 62a, in a section in the width direction (FIG. 8). Note that if the planarization of the surface of the conductive paste layer 91 by the calendering roll 100 as shown in FIG. 7B is not performed, no corner portion is present at the conductive paste layer 91, and the ferrite paste layer 72 may flow transversely. For this reason, a formed coil conductor does not include a first surface and a second surface in a section in a width direction.

The second angle θ2 of the inner end face 61 and the second angle θ4 of the outer end face 62 in a section in a width direction of a coil conductor can be appropriately changed by changing the length X of a portion where the ferrite paste layer 72 overlaps with a part of each end portion of the conductive paste layer 91 and the thickness Y of the portion where the ferrite paste layer 72 overlaps with the part of the end portion of the conductive paste layer 91.

In the multilayer coil component according to the present disclosure, the coil is preferably composed of two or more layers of coil conductors which are electrically connected in parallel via a via conductor and are present at different layers.

Since if a coil is composed of two or more layers of coil conductors which are electrically connected in parallel via a via conductor and are present at different layers, a DC resistance of the coil decreases, an even larger current can be added.

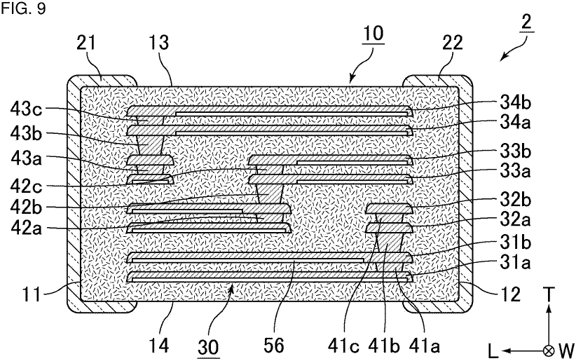

FIG. 9 is an LT sectional view schematically showing an internal structure of a different example of the multilayer coil component according to the present disclosure.

In a multilayer coil component 2, the multilayer body 10 includes a plurality of coil conductors 31a, 31b, 32a, 32b, 33a, 33b, 34a, and 34b and a plurality of via conductors 41a, 41b, 41c, 42a, 42b, 42c, 43a, 43b, and 43c. In FIG. 9, the coil conductors 31a, 31b, 32a, 32b, 33a, 33b, 34a, and 34b are arranged in order from a lower side in a height direction T. The coil conductor 31a and the coil conductor 31b are the same in coil conductor pattern. Similarly, the coil conductor 32a and the coil conductor 32b, the coil conductor 33a and the coil conductor 33b, and the coil conductor 34a and the coil conductor 34b are each the same in coil conductor pattern.

The coil conductors 31a and 31b are electrically connected together via the via conductor 41a. The coil conductors 31b and 32a are electrically connected together via the via conductor 41b. The coil conductors 32a and 32b are electrically connected together via the via conductor 41c. Note that the via conductor 41a, the via conductor 41b, and the via conductor 41c are present so as to overlap as viewed from a stacking direction of the multilayer body.

Similarly, the coil conductors 32a and 32b are electrically connected together via the via conductor 42a. The coil conductors 32b and 33a are electrically connected together via the via conductor 42b. The coil conductors 33a and 33b are electrically connected together via the via conductor 42c. Note that the via conductor 42a, the via conductor 42b, and the via conductor 42c are present so as to overlap as viewed from a stacking direction of the multilayer body.

Similarly, the coil conductors 33a and 33b are electrically connected together via the via conductor 43a. The coil conductors 33b and 34a are electrically connected together via the via conductor 43b. The coil conductors 34a and 34b are electrically connected together via the via conductor 43c. Note that the via conductor 43a, the via conductor 43b, and the via conductor 43c are present so as to overlap as viewed from a stacking direction of the multilayer body.

With the configuration as in FIG. 9, the coil conductor 31a and the coil conductor 31b are electrically connected in parallel. Similarly, the coil conductor 32a and the coil conductor 32b, the coil conductor 33a and the coil conductor 33b, and the coil conductor 34a and the coil conductor 34b are each electrically connected in parallel.

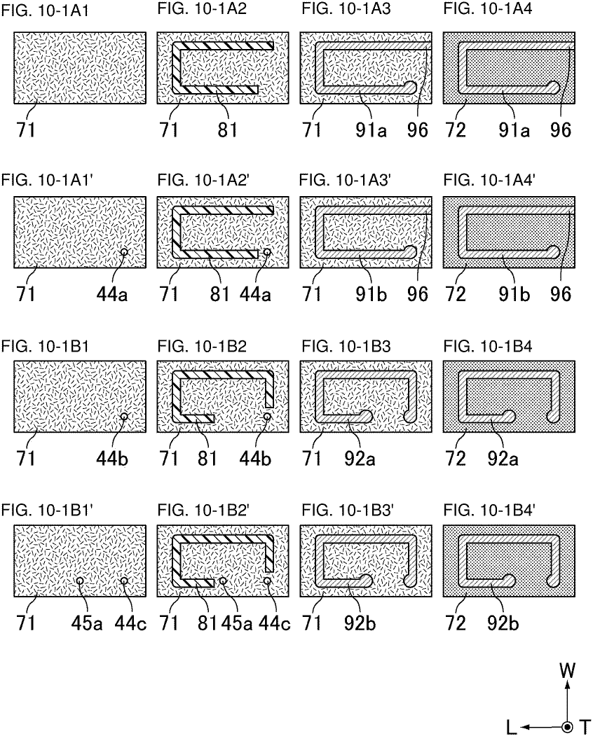

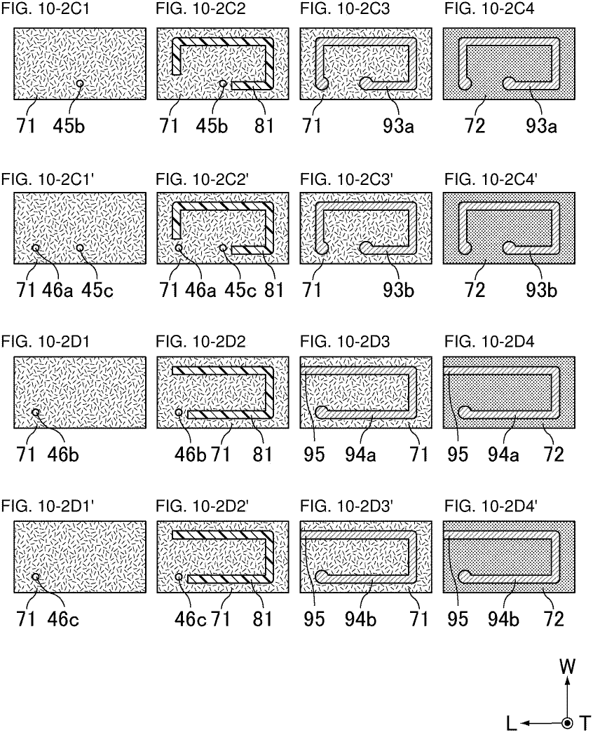

A method for producing the multilayer coil component 2 will next be described with reference to FIGS. 10-1A1 to 10-1B4′ and 10-2C1 to 10-2D4′.

FIGS. 10-1A1 to 10-1B4′ and 10-2C1 to 10-2D4′ are exploded views schematically showing a method for producing a multilayer body of the different example of the multilayer coil component according to the present disclosure.

FIGS. 10-1A1 to 10-1B4′ and 10-2C1 to 10-2D4′ show a method for producing the multilayer body 10 in the multilayer coil component 2.

Pattern sheet 1 is produced by the same method as in FIG. 6A1 to 6A4 (FIG. 10-1A1 to 10-1A4).

Then, pattern sheet 1′ that is the same as pattern sheet 1 except that a via hole 44a is present is produced (FIG. 10-1A1 to 10-1A4′). A conductive paste, with which the via hole 44a of pattern sheet 1′ is filled, serves as the via conductor 41a after firing.

Then, pattern sheet 2 is produced by the same method as in FIG. 6B1 to 6B4 (FIG. 10-1B1 to 10-1B4). Note that a conductive paste, with which a via hole 44b of pattern sheet 2 is filled, serves as the via conductor 41b after firing.

Then, pattern sheet 2′ that is the same as pattern sheet 2 except that a via hole 45a is present is produced (FIG. 10-1B1′ to 10-1B4′). Note that a conductive paste, with which a via hole 44c of pattern sheet 2′ is filled, serves as the via conductor 41c after firing. A conductive paste, with which the via hole 45a of pattern sheet 2′ is filled, serves as the via conductor 42a after firing.

Pattern sheet 3 and pattern sheet 4 are produced by the same procedures as pattern sheet 2 (FIG. 10-2C1 to 10-2C4 and FIG. 10-2D1 to 10-2D4). Pattern sheet 3′ and pattern sheet 4′ are produced by the same procedures as pattern sheet 2′ (FIG. 10-2C1′ to 10-2C4′ and FIG. 10-2D1′ to 10-2D4′).

Pattern sheet 1, pattern sheet 1′, pattern sheet 2, pattern sheet 2′, pattern sheet 3, pattern sheet 3′, pattern sheet 4, and pattern sheet 4′ produced in the above-described manner are stacked in order, and a predetermined number of unprinted ferrite sheets are stacked on the top and bottom. The stacked sheets are subjected to pressurization and pressure bonding processing under a condition with a temperature not less than 70° C. and not more than 90° C. (i.e., from 70° C. to 90° C.) and a pressure not less than 60 MPa and not more than 100 MPa (i.e., from 60 MPa to 100 MPa), thereby obtaining a multilayer body block (element assembly).

In terms of steps other than the above-described ones, the same steps as for the multilayer coil component 1 are performed, thereby obtaining the multilayer coil component 2 as shown in FIG. 9.

Conductive paste layers 91a, 91b, 92a, 92b, 93a, 93b, 94a, and 94b in FIG. 10-1A1 to 10-1B4′ or FIG. 10-2C1 to 10-2D4′ serve as the coil conductors 31a, 31b, 32a, 32b, 33a, 33b, 34a, and 34b, respectively, after firing. Conductive pastes, with which the via holes 44a, 44b, 44c, and 45a and via holes 45b, 45c, 46a, 46b, and 46c in FIG. 10-1A1 to 10-1B4′ or FIG. 10-2C1 to 10-2D4′are filled, serve as the via conductors 41a, 41b, 41c, 42a, 42b, 42c, 43a, 43b, and 43c, respectively, after firing.

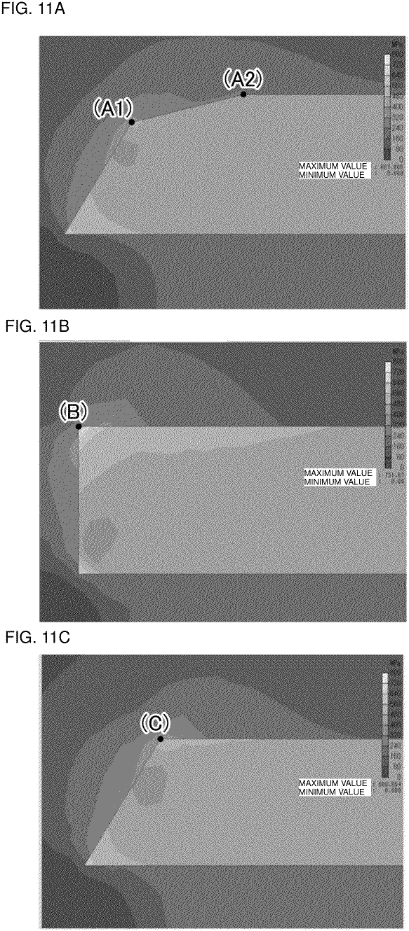

FIGS. 11A-11C are views showing results of simulating stress applied to a corner portion of a coil conductor in a process of firing a multilayer coil component.

For simulation of stress applied to a corner portion of a coil conductor, a multilayer coil component according to Example 1 with a coil conductor having a shape including a first surface and a second surface at an end face, a multilayer coil component according to Comparative Example 1 with a coil conductor having a rectangular shape, and a multilayer coil component according to Comparative Example 2 with a coil conductor having a trapezoidal shape were used.

Note that the stress simulation was performed using Femtet® from Murata Software Co., Ltd.

FIG. 11A illustrates a result of simulating stresses applied to a coil conductor portion and an insulating layer in the multilayer coil component according to Example 1 with the coil conductor having the shape including the first surface and the second surface at the end face.

FIG. 11B illustrates a result of simulating stress applied to a coil conductor portion and an insulating layer in the multilayer coil component according to Comparative Example 1 with the coil conductor having the rectangular shape.

FIG. 11C illustrates a result of simulating stress applied to a coil conductor portion and an insulating layer in the multilayer coil component according to Comparative Example 2 with the coil conductor having the trapezoidal shape.

Comparison between a stress applied to a corner portion (A1) where the first surface and the second surface of the coil conductor are in contact with each other in FIG. 11A and a stress applied to an upper left corner portion (B) of the coil conductor in FIG. 11B has found that the stress applied to the corner portion (A1) was 0.70 times the stress applied to the corner portion (B).

Comparison between a stress applied to a corner portion (A2) which is an end portion not in contact with the first surface in the second surface of the coil conductor in FIG. 11A and the stress applied to the upper left corner portion (B) of the coil conductor in FIG. 11B has found that the stress applied to the corner portion (A2) was 0.66 times the stress applied to the corner portion (B).

It is apparent from this that concentration of stress on a corner portion of a coil conductor is lower by 30% or more to 34% or less (i.e., from 30% to 34%) in the multilayer coil component according to Example 1 than in the multilayer coil component according to Comparative Example 1.

Comparison between the stress applied to the corner portion (A1) where the first surface and the second surface of the coil conductor are in contact with each other in FIG. 11A and a stress applied to an upper left corner portion (C) of the coil conductor in FIG. 11C has found that the stress applied to the corner portion (A1) was 0.89 times the stress applied to the corner portion (C).

Comparison between the stress applied to the corner portion (A2) that is the end portion not in contact with the first surface in the second surface in FIG. 11A and the stress applied to the upper left corner portion (C) of the coil conductor in FIG. 11C has found that the stress applied to the corner portion (A2) was 0.83 times the stress applied to the corner portion (C).

It is apparent from this that concentration of stress on a corner portion of a coil conductor is lower by 11% or more to 17% or less (i.e., from 11% to 17%) in the multilayer coil component according to Example 1 than in the multilayer coil component according to Comparative Example 2.

The above-described results show that concentration of stress on a corner portion of a coil conductor is inhibited in a multilayer coil component according to the present disclosure, as compared with a multilayer coil component with a coil conductor having a rectangular shape or a trapezoidal shape.

What is claimed is:

1. A multilayer coil component comprising:
a multilayer body which includes a plurality of insulating layers that are stacked, and which incorporates a coil; and
an outer electrode on an outer surface of the multilayer body and electrically connected to the coil, wherein
the coil is configured by a plurality of coil conductors which are stacked together with the insulating layers being electrically connected together,
the coil conductors each includes an inner end face and an outer end face which face each other in a direction orthogonal to a stacking direction of the multilayer body in a section in a width direction of the coil conductor,
the inner end face is on an inner side of the multilayer body in the section in the width direction of the coil conductor,
the outer end face is on an outer side of the multilayer body in the section in the width direction of the coil conductor, and
at least one end face of the inner end face and the outer end face in at least one of the coil conductors includes a first surface and a second surface which is continuous with the first surface and is different in an angle with respect to a plane perpendicular to the stacking direction from the first surface.

2. The multilayer coil component according to claim 1, wherein
if a plane on a side of the coil conductor of the plane perpendicular to the stacking direction is regarded as a reference plane, an angle with respect to the reference plane at an end portion of the first surface which is not in contact with the second surface is defined as a first angle, and an angle with respect to the reference plane at an end portion of the second surface which is in contact with the first surface is defined as a second angle, one angle of the first angle and the second angle is not more than 90°, and the other angle is less than 90°.

3. The multilayer coil component according to claim 2, wherein
the one angle of the first angle and the second angle is from 40° to 85°, and the other angle is from 5° to 30°.

4. The multilayer coil component according to claim 2, wherein
the first angle is larger than the second angle.

5. The multilayer coil component according to claim 1, wherein
a void portion is present between the at least one of the coil conductors that includes the first surface and the second surface and the insulating layer.

6. The multilayer coil component according to claim 5, wherein
the coil conductor includes two principal surfaces which face each other in the stacking direction, and
the void portion is in contact with either one of the principal surfaces.

7. The multilayer coil component according to claim 6, wherein
a width of the void portion is smaller than a width of the coil conductor.

8. The multilayer coil component according to claim 1, wherein
the coil includes two or more layers of the coil conductors which are electrically connected in parallel via a via conductor and are present at different layers.

9. The multilayer coil component according to claim 3, wherein
the first angle is larger than the second angle.

10. The multilayer coil component according to claim 2, wherein
a void portion is present between the at least one of the coil conductors that includes the first surface and the second surface and the insulating layer.

11. The multilayer coil component according to claim 3, wherein
a void portion is present between the at least one of the coil conductors that includes the first surface and the second surface and the insulating layer.

12. The multilayer coil component according to claim 4, wherein
a void portion is present between the at least one of the coil conductors that includes the first surface and the second surface and the insulating layer.

13. The multilayer coil component according to claim 9, wherein
a void portion is present between the at least one of the coil conductors that includes the first surface and the second surface and the insulating layer.

14. The multilayer coil component according to claim 2, wherein
the coil includes two or more layers of the coil conductors which are electrically connected in parallel via a via conductor and are present at different layers.

15. The multilayer coil component according to claim 3, wherein
the coil includes two or more layers of the coil conductors which are electrically connected in parallel via a via conductor and are present at different layers.

16. The multilayer coil component according to claim 4, wherein
the coil includes two or more layers of the coil conductors which are electrically connected in parallel via a via conductor and are present at different layers.

17. The multilayer coil component according to claim 5, wherein
the coil includes two or more layers of the coil conductors which are electrically connected in parallel via a via conductor and are present at different layers.

18. The multilayer coil component according to claim 6, wherein
the coil includes two or more layers of the coil conductors which are electrically connected in parallel via a via conductor and are present at different layers.

19. The multilayer coil component according to claim 7, wherein
the coil includes two or more layers of the coil conductors which are electrically connected in parallel via a via conductor and are present at different layers.

20. The multilayer coil component according to claim 9, wherein
the coil includes two or more layers of the coil conductors which are electrically connected in parallel via a via conductor and are present at different layers.
